(19) United States
(12) Patent Application Publication
(10) Pub. No.: US 2023/0306074 A1
(43) Pub. Date: Sep. 28, 2023

(54) COMBINATORIAL OPTIMIZATION PROBLEM INFORMATION TRANSMISSION DEVICE AND COMBINATORIAL OPTIMIZATION PROBLEM SOLUTION DEVICE

(71) Applicant: NEC Corporation, Minato-ku, Tokyo (JP)

(72) Inventors: Motoi SUZUKI, Tokyo (JP); Hiroaki INOUE, Tokyo (JP); Takuya ARAKI, Tokyo (JP); Fumiyo TAKANO, Tokyo (JP); Yuki KOBAYASHI, Tokyo (JP); Hiroshi CHISHIMA, Tokyo (JP); Takahiro NISHIMURA, Tokyo (JP); Akihiro YATABE, Tokyo (JP)

(73) Assignee: NEC Corporation, Minato-ku, Tokyo (JP)

(21) Appl. No.: 18/020,526

(22) PCT Filed: Aug. 20, 2020
(86) PCT No.: PCT/JP2020/031450

§ 371 Date: Feb. 9, 2023

(51) Int. Cl. G06F 17/11; G06F 17/16

(52) U.S. Cl. CPC G06F 17/11; G06F 17/16

(57) ABSTRACT

The difference matrix calculation means 72 calculates a difference matrix which is a difference between a first matrix representing a combinatorial optimization problem for which a solution was found last time and a second matrix representing the latest combinatorial optimization problem. The difference matrix compression means 73 compresses the difference matrix. The transmission means 74 transmits the difference matrix after compression to a combinatorial optimization problem solution device that finds a solution to the combinatorial optimization problem.

### TECHNICAL FIELD

The present invention relates to a combinatorial optimization problem information transmission device which transmits information on a combinatorial optimization problem, a combinatorial optimization problem solution device which finds a solution to the combinatorial optimization problem, a solution system including the combinatorial optimization problem information transmission device and the combinatorial optimization problem solution device, a combinatorial optimization problem information transmission method, a combinatorial optimization problem solution method, a computer-readable recording medium in which a combinatorial optimization problem information transmission program is recorded, and a computer-readable recording medium in which a combinatorial optimization problem solution program is recorded.

### BACKGROUND ART

An energy function of the Ising model is used in solving combinatorial optimization problems. Examples of combinatorial optimization problems include the work shift optimization problem, the traveling salesman problem, and the knapsack problem. However, combinatorial optimization problems are not limited to these problems.

The Ising model is a model in statistical mechanics that represents the behavior of a magnetic material by individual spins, and it is also applicable to solving combinatorial optimization problems. In the Ising model, the states of individual spins are represented by “1” or “−1”.

“1” in the Ising model can be referred to as the first value. “−1” in the Ising model can be referred to as the second value.

When solving a combinatorial optimization problem, the first step is to create an expression representing the energy in the combinatorial optimization problem. For example, when solving the traveling salesman problem, an expression representing the energy in the traveling salesman problem is created. Then, the expression representing the energy in the combinatorial optimization problem is converted to the energy function of the Ising model. This conversion method is known.

The energy function of the Ising model is expressed as in Expression (1) below.

[Math. 1]

H_{Ising}=ΣᵢⱼJᵢⱼsᵢsⱼ+Σᵢhᵢsᵢ (1)

Both i and j in Expression (1) are variables representing a spin. In addition, sᵢ in Expression (1) is a variable representing the state of spin i, and sⱼ is a variable representing the state of spin j. hᵢ in Expression (1) is a constant corresponding to spin i. For each possible value of i, hᵢ is determined as a constant. Jᵢⱼ in Expression (1) is a constant corresponding to a combination of spin i and spin j. For each combination of possible value of i and possible value of j, Jᵢⱼ is determined as a constant.

There are K² constants Jᵢⱼ in Expression (1) when the number of spins is K. A set of constants Jᵢⱼ is represented by a matrix with K rows and K columns That is, the constant Jᵢⱼ corresponding to a combination of two spins is an element of the matrix with K rows and K columns Hereafter, this matrix with K rows and K columns is denoted by the sign α. The matrix α is a symmetric matrix.

There are K constants hᵢ in Expression (1) when the number of spins is K. A set of constants hᵢ is then represented by a vector with K elements. Each constant hᵢ corresponding to each spin is an element of this vector. Hereafter, this vector is denoted by the sign β.

It can be said that the matrix α and the vector β represent a combinatorial optimization problem. Given the energy function of Expression (1), the matrix α and the vector β are also given.

However, depending on the type of combinatorial optimization problem, the second term on the right side may not exist (in other words, the vector β may not exist) in the energy function shown in Expression (1).

Given the energy function shown in Expression (1), the optimal states (1 or −1) of individual spins are found. The optimal states of individual spins are states of individual spins such that the energy indicated by the energy function is as small as possible, or states of individual spins such that the energy indicated by the energy function is as large as possible. The optimal states of individual spins are, for example, externally designated as either the states of individual spins in which the energy indicated by the energy function is as small as possible, or the states of individual spins in which the energy indicated by the energy function is as large as possible. The optimal states of individual spins so obtained represent the solution to the combinatorial optimization problem.

In addition, PTL 1 describes a system that handles difference information between the latest data and the previously transmitted data.

### CITATION LIST

### Patent Literature

PTL 1: Japanese Patent Application Laid-Open No. 2000-194613

### SUMMARY OF INVENTION

### Technical Problem

As a system for finding a solution to a combinatorial optimization problem, a system including a terminal and a server is considered. That is, it is considered that the matrix α and the vector β representing the combinatorial optimization problem are input to the terminal, which transmits the matrix α and the vector β to the server, and the server uses the matrix α and the vector β to find the solution to the combinatorial optimization problem and returns the solution to the terminal.

In a case, the same type of combinatorial optimization problem is solved repeatedly. In this case, if the terminal transmits the matrix α and the vector β to the server each time the server tries to find a solution to the combinatorial optimization problem, the data volume of the matrix α is large, resulting in a large communication volume. Therefore, the communication cost of matrix α becomes high, and the transmission of matrix α from the terminal to the server becomes a bottleneck in the entire process.

Therefore, an object of the present invention is to reduce the communication volume of information when information on a combinatorial optimization problem is transmitted from one device to another device, and the device receiving the information finds the solution to the combinatorial optimization problem.

### Solution to Problem

A combinatorial optimization problem information transmission device according to the present invention includes: difference matrix calculation means for calculating a difference matrix which is a difference between a first matrix representing a combinatorial optimization problem for which a solution was found last time and a second matrix representing the latest combinatorial optimization problem; difference matrix compression means for compressing the difference matrix; and transmission means for transmitting the difference matrix after compression to a combinatorial optimization problem solution device that finds a solution to the combinatorial optimization problem.

A combinatorial optimization problem solution device according to the present invention includes: matrix storage means for storing a first matrix representing a combinatorial optimization problem for which a solution was found last time; receiving means for receiving a result of compression of a difference matrix which is a difference between the first matrix and a second matrix representing the latest combinatorial optimization problem, from a combinatorial optimization problem information transmission device that transmits information on the combinatorial optimization problem; difference matrix restoration means for restoring the difference matrix from the result of compression; matrix derivation means for deriving the second matrix based on the restored difference matrix and the first matrix; solution means for finding a solution to the combinatorial optimization problem using the derived second matrix; and solution transmission means for transmitting the solution to the combinatorial optimization problem information transmission device.

A solution system according to the present invention includes: a combinatorial optimization problem information transmission device that transmits information on a combinatorial optimization problem; and a combinatorial optimization problem solution device that finds a solution to the combinatorial optimization problem, wherein the combinatorial optimization problem information transmission device comprises: difference matrix calculation means for calculating a difference matrix which is a difference between a first matrix representing the combinatorial optimization problem for which the solution was found last time and a second matrix representing the latest combinatorial optimization problem; difference matrix compression means for compressing the difference matrix; and transmission means for transmitting the difference matrix after compression to the combinatorial optimization problem solution device, wherein the combinatorial optimization problem solution device comprises: matrix storage means for storing the first matrix; receiving means for receiving the difference matrix after compression from the transmission means of the combinatorial optimization problem information transmission device; difference matrix restoration means for restoring the difference matrix from the difference matrix after compression; matrix derivation means for deriving the second matrix based on the restored difference matrix and the first matrix; solution means for finding the solution to the combinatorial optimization problem using the derived second matrix; and solution transmission means for transmitting the solution to the combinatorial optimization problem information transmission device.

A combinatorial optimization problem information transmission method according to the present invention is implemented by a computer, and comprises: calculating a difference matrix which is a difference between a first matrix representing a combinatorial optimization problem for which a solution was found last time and a second matrix representing the latest combinatorial optimization problem; compressing the difference matrix; and transmitting the difference matrix after compression to a combinatorial optimization problem solution device that finds a solution to the combinatorial optimization problem.

A combinatorial optimization problem solution method according to the present invention is implemented by a computer, and comprises: storing a first matrix representing a combinatorial optimization problem for which a solution was found last time; receiving a result of compression of a difference matrix which is a difference between the first matrix and a second matrix representing the latest combinatorial optimization problem, from a combinatorial optimization problem information transmission device that transmits information on the combinatorial optimization problem; restoring the difference matrix from the result of compression; deriving the second matrix based on the restored difference matrix and the first matrix; finding a solution to the combinatorial optimization problem using the derived second matrix; and transmitting the solution to the combinatorial optimization problem information transmission device.

A computer-readable recording medium according to the present invention is a computer-readable recording medium in which a combinatorial optimization problem information transmission program is recorded, wherein the combinatorial optimization problem information transmission program causes a computer to execute: a difference matrix calculation process of calculating a difference matrix which is a difference between a first matrix representing a combinatorial optimization problem for which a solution was found last time and a second matrix representing the latest combinatorial optimization problem; a difference matrix compression process of compressing the difference matrix; and a transmission process of transmitting the difference matrix after compression to a combinatorial optimization problem solution device that finds a solution to the combinatorial optimization problem.

A computer-readable recording medium according to the present invention is a computer-readable recording medium in which a combinatorial optimization problem solution program is recorded, wherein the combinatorial optimization problem solution program causes a computer to execute: a matrix storage process of storing a first matrix representing a combinatorial optimization problem for which a solution was found last time; a receiving process of receiving a result of compression of a difference matrix which is a difference between the first matrix and a second matrix representing the latest combinatorial optimization problem, from a combinatorial optimization problem information transmission device that transmits information on the combinatorial optimization problem; a difference matrix restoration process of restoring the difference matrix from the result of compression; a matrix derivation process of deriving the second matrix based on the restored difference matrix and the first matrix; a solution process of finding a solution to the combinatorial optimization problem using the derived second matrix; and a solution transmission process of transmitting the solution to the combinatorial optimization problem information transmission device.

### Advantageous Effects of Invention

According to the present invention, when information on a combinatorial optimization problem is transmitted from one device to another device, and the device receiving the information finds the solution to the combinatorial optimization problem, the communication volume of information can be reduced.

### BRIEF DESCRIPTION OF DRAWINGS

FIG. 1 It depicts a block diagram showing an example configuration of a solution system of the example embodiment of the present invention.

FIG. 2 It depicts a schematic diagram showing an example of a difference matrix when the elements of the second row and the second column are different between previous matrix and latest matrix, and the other elements are common in both matrices.

FIG. 3 It depict a schematic diagram showing an example of a graph in which the vertices are divided into two groups.

FIG. 4 It depicts a sequence diagram showing an example of the processing flow in the case where the latest matrix and the latest vector are input to the terminal for the first time.

FIG. 5 It depicts a sequence diagram showing an example of the processing flow in the case where the latest matrix and the latest vector are input to the terminal for the second and subsequent times.

FIG. 6 It depicts a sequence diagram showing an example of the processing flow in the case where the latest matrix and the latest vector are input to the terminal for the second and subsequent times.

FIG. 7 It depicts a block diagram showing an example of computer configuration of for realizing a combinatorial optimization problem information transmission device and a combinatorial optimization problem solution device.

FIG. 8 It depicts a block diagram showing an overview of the combinatorial optimization problem information transmission device of the present invention.

FIG. 9 It depicts a block diagram showing an overview of the combinatorial optimization problem solution device of the present invention.

### DESCRIPTION OF EMBODIMENTS

An example embodiment of the present invention is described below with reference to the drawings.

In the following explanation, the case where the matrix α and the vector β representing a combinatorial optimization problem are given by the energy function of the Ising model.

When solving a combinatorial optimization problem repeatedly, many elements of the matrix α representing the combinatorial optimization problem may remain unchanged from the previous time, and only some elements of the matrix α may change from the previous time. The present invention is suitable for solving a combinatorial optimization problem represented by such a matrix.

An example of a combinatorial optimization problem in which many elements of the matrix α representing the combinatorial optimization problem remain unchanged from the previous time while only some elements of the matrix α change from the previous time when solving the combinatorial optimization problem repeatedly is the dynamic portfolio optimization problem in stock trading. The problem is to identify the optimal allocation of a specified amount of funds to which stocks. Here, the elements of the matrix α representing the dynamic portfolio optimization problem are affected by the rate of return, expected rate of return, etc. of each stock. However, the change in the rate of return, expected rate of return, etc. of each stock is small when only a predetermined period of time has passed, and as a result, when comparing the matrix α when the solution to the dynamic portfolio optimization problem is obtained the last time and the matrix α when the solution to the latest dynamic portfolio optimization problem is obtained, many elements of the matrix remain unchanged from the previous time and only some elements of the matrix change from the previous time.

The case in which many elements of the matrix α representing the combinatorial optimization problem remain unchanged from the previous time and only some elements of the matrix α change from the previous time is not limited to the case in which the combinatorial optimization problem is solved repeatedly over time as described above.

For example, even when repeatedly solving a puzzle in which the elements of matrix α representing the combinatorial optimization problem are significantly affected by the rules, many elements of matrix α representing the combinatorial optimization problem (in this example, the puzzle) remain unchanged from the previous time, and only some elements of matrix α change from the previous time.

Also, for example, when dividing a year's worth of work shift optimization problems into month-by-month work shift optimization problems and finding the solution to each of the 12 work shift optimization problems, many elements of the matrix α representing the combinatorial optimization problem (in this example, the work shift optimization problem) remain unchanged from the previous time, and only some elements of the matrix α change from the previous time.

As mentioned above, the present invention is suitable for solving a combinatorial optimization problem represented by such a matrix.

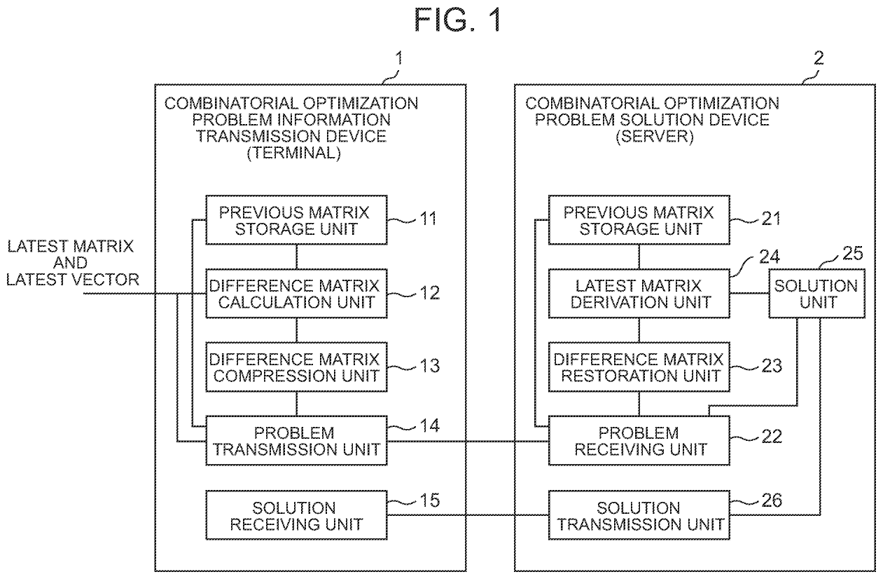

FIG. 1 is a block diagram showing an example configuration of a solution system of the example embodiment of the present invention. The solution system shown in FIG. 1 includes a combinatorial optimization problem information transmission device 1 that transmits information on a combinatorial optimization problem and a combinatorial optimization problem solution device 2 that finds a solution to the combinatorial optimization problem.

The combinatorial optimization problem information transmission device 1 is realized, for example, by a terminal. Hereafter, the case in which the combinatorial optimization problem information transmission device 1 is realized by a terminal will be used as an example, and the combinatorial optimization problem information transmission device 1 will be referred to as the terminal 1.

For example, the combinatorial optimization problem solution device 2 is realized by a server, such as a cloud server. Hereafter, the case in which the combinatorial optimization problem solution device 2 is realized by a server will be used as an example, and the combinatorial optimization problem solution device 2 will be referred to as the server 2.

The terminal 1 and the server 2 are communicatively connected via a communication network (not shown).

In the case of repeatedly solving a combinatorial optimization problem, the matrix α and the vector β representing the latest combinatorial optimization problem are denoted as the latest matrix and the latest vector, respectively. The matrix α representing the combinatorial optimization problem for which the solution was found last time is referred to as the previous matrix. When comparing the previous matrix and the latest matrix, many of the elements are common, and only some of the elements are different.

The terminal 1 includes a previous matrix storage unit 11, a difference matrix calculation unit 12, a difference matrix compression unit 13, a problem transmission unit 14, and a solution receiving unit 15.

The latest matrix and the latest vector representing the latest combinatorial optimization problem are input to the terminal 1. The difference matrix calculation unit 12 receives the latest matrix and the problem transmission unit 14 receives the latest vector.

However, when the latest matrix and the latest vector are input for the first time, the problem transmission unit 14 receives the latest matrix and the latest vector, and the problem transmission unit 14 stores that latest matrix in the previous matrix storage unit 11, and further transmits the latest matrix and the latest vector to the server 2.

As already explained, there is a case where the vector β representing the combinatorial optimization problem does not exist. That is, there is a case where the second term on the right side does not exist in the energy function shown in Expression (1).

The previous matrix storage unit 11 is a storage device that stores the matrix α (previous matrix) representing the combinatorial optimization problem for which a solution was obtained last time. It is assumed that the latest matrix and the latest vector are input while the previous matrix exists. In this case, the previous matrix may be referred to as a first matrix and the latest matrix may be referred to as a second matrix.

In the following explanation, the case where the latest matrix and the latest vector are input while the previous matrix is already stored in the previous matrix storage unit 11, the difference matrix calculation unit 12 receives the latest matrix, and the problem transmission unit 14 receives the latest vector is described.

The difference matrix calculation unit 12 calculates a difference matrix, which is the difference between the input latest matrix and the previous matrix stored in the previous matrix storage unit 11. Specifically, the difference matrix calculation unit 12 calculates the difference matrix by subtracting the previous matrix from the latest matrix.

As mentioned above, when comparing the previous matrix and the latest matrix, many elements are common and only some elements are different. Therefore, the difference matrix is a sparse matrix.

The latest matrix and the previous matrix are symmetric matrices since they both represent combinatorial optimization problems. Therefore, the difference matrix is also a symmetric matrix.

After calculating the difference matrix, the difference matrix calculation unit 12 updates the previous matrix stored in the previous matrix storage unit 11 with the latest matrix. The latest matrix stored in the previous matrix storage unit 11 is treated as the previous matrix the next time the latest matrix is input.

The difference matrix compression unit 13 compresses the difference matrix calculated by the difference matrix calculation unit 12. As described above, the difference matrix is a sparse matrix. Therefore, the difference matrix can be compressed.

The difference matrix compression unit 13 may compress the difference matrix using the CSR (Compressed Sparse Row) method.

The difference matrix compression unit 13 may also compress the difference matrix using the COO (COOdinate) method.

Also, there is a combinatorial optimization problem having a property in which, when comparing the previous matrix and the latest matrix, the elements of a row and the column corresponding to the row (e.g., column p in the case where the row is row p) differ, while the other elements remain unchanged (in other words, they are common). An example of such a combinatorial optimization problem is the Maxcut problem, which is explained below.

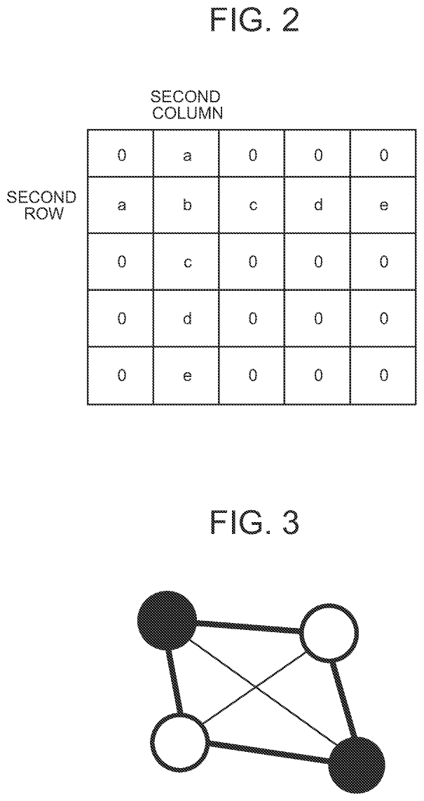

In a combinatorial optimization problem with the above property, when comparing the previous matrix and the latest matrix, it is assumed that the elements of a row (in this example, the second row) and the second column corresponding to that row are different, and the other elements are common. The difference matrix in this case is shown schematically in FIG. 2. In the difference matrix shown in FIG. 2, all elements except for the second row and the second column are zero. There may be elements that are zero in the second row and the second column. Since the difference matrix is also a symmetric matrix, the same group of elements is obtained whether the entire second row or the entire second column is extracted (see FIG. 2).

In this example, the row whose element set differs between the previous matrix and the latest matrix is the second row, and the difference matrix compression unit 13 may determine the second row of the difference matrix corresponding to the second row, and the index “2” of the row may be defined as the result of the difference matrix compression. In this example, the column whose element set differs between the previous matrix and the latest matrix is the second column, and the difference matrix compression unit 13 may determine the second column of the difference matrix corresponding to the second column, and the index “2” of the column may be defined as the result of the difference matrix compression.

Even when the rows and columns whose element groups differ between the previous matrix and the latest matrix are other than the second row and the second column, the compression result of the difference matrix can be determined in the same way.

The above compression method is referred to as the third compression method for convenience. The third compression method is applicable to the case where a solution to a combinatorial optimization problem with the above property is obtained. That is, when repeatedly solving a combinatorial optimization problem with the above property, the difference matrix compression unit 13 may compress the difference matrix using the third compression method.

The following is an explanation of the Maxcut problem with the above property. Consider an arbitrary graph whose vertices are connected by edges. It is assumed that the vertices are divided into two groups. An example of such a graph with vertices divided into two groups is shown in FIG. 3. In the graph shown in FIG. 3, the vertices shown in black belong to the same group and the vertices shown in white belong to the same group. In FIG. 3, edges connecting vertices belonging to the same group are shown as thin lines, and edges connecting vertices belonging to different groups are shown as thick lines. A weight is assigned to each edge. The Maxcut problem is a combinatorial optimization problem in which the vertices are divided into two groups so that the sum of the weights of the edges connecting the vertices belonging to different groups is maximized.

The energy function of the Ising model in the Maxcut problem is expressed as in Expression (2) below.

[Math. 2]

H_{Ising}=ΣᵢⱼJᵢⱼsᵢsⱼ (2)

Compared to Expression (1), Expression (2) does not have the second term on the right side of Expression (1). Therefore, in the Maxcut problem, the vector β does not exist. Thus, when the vector β does not exist, no processing related to vector in the present example embodiment is required.

It is assumed that the two groups are G1 and G2. In Expression (2), i and j are variables representing vertices. sᵢ is a variable that takes “−1” when vertex i belongs to group G1 and takes “1” when vertex i belongs to group G2. Similarly, sⱼ is a variable that takes “−1” when vertex j belongs to group G1 and takes “1” when vertex j belongs to group G2. The constant Jᵢⱼ is the weight of the edge connecting vertex i and vertex j. Here, it is assumed that the weight of the edge connecting vertex i and vertex j is the distance between vertex i and vertex j.

It is assumed that the solution to the Maxcut problem is repeatedly obtained while changing the position of only one vertex each time. In this case, in the matrix α representing the Maxcut problem, only the elements of the rows and the column corresponding to the vertex change, while the other elements remain unchanged. Therefore, when repeatedly obtaining the solution to such a Maxcut problem, it is preferable to use the third compression method described above as the compression method for the difference matrix.

In the present example embodiment, the CSR method, the COO method, and the third compression method for the difference matrix are listed. Which compression method is adopted is specified, for example, by the user of the solution system.

The problem transmission unit 14 transmits the difference matrix after compression and the latest vector to the server 2.

As already explained, when the latest matrix and the latest vector are input for the first time, the problem transmission unit 14 transmits the latest matrix and the latest vector to the server 2.

The solution receiving unit 15 receives the solution to the combinatorial optimization problem from the server 2.

The problem transmission unit 14 and the solution receiving unit 15 are realized, for example, by a CPU (Central Processing Unit) of a computer that operates according to a combinatorial optimization problem information transmission program, and by a communication interface of the computer. In this case, the CPU may read the combinatorial optimization problem information transmission program from a program recording medium such as a program storage device of the computer, and operates as the problem transmission unit 14 and the solution receiving unit 15 according to the program and using the communication interface.

The difference matrix calculation unit 12 and the difference matrix compression unit 13 are realized, for example, by the CPU of the computer that operates according to the combinatorial optimization problem information transmission program. In this case, the CPU may read the combinatorial optimization problem information transmission program from the program recording medium such as the program storage device of the computer, as described above, and operate as the difference matrix calculation unit 12 and the difference matrix compression unit 13.

The previous matrix storage unit 11 is realized by a storage device provided by the computer.

The server 2 includes a previous matrix storage unit 21, a problem receiving unit 22, a difference matrix restoration unit 23, an latest matrix derivation unit 24, a solution unit 25, and a solution transmission unit 26.

Similar to the previous matrix storage unit 11 of the terminal 1, the previous matrix storage unit 21 of the server 2 is a storage device that stores the matrix α (previous matrix) representing the combinatorial optimization problem for which a solution was obtained last time.

The problem receiving unit 22 receives the difference matrix after compression and the latest vector transmitted from the problem transmission unit 14. The problem receiving unit 22 then inputs the difference matrix after compression to the difference matrix restoration unit 23 and inputs the latest vector to the solution unit 25.

When the latest matrix and the latest vector are input to the terminal 1 for the first time, the previous matrix is not stored in the previous matrix storage unit 21. In this case, when the problem receiving unit 22 receives the latest matrix and the latest vector from problem transmission unit 14, the problem receiving unit 22 inputs the latest matrix and the latest vector to the solution unit and stores the latest matrix in the previous matrix storage unit 21. The latest matrix stored in the previous matrix storage unit 21 is treated as the previous matrix the next time the problem receiving unit 22 receives the difference matrix after compression and the latest vector.

The difference matrix restoration unit 23 restores the difference matrix from the difference matrix after compression (in other words, the compression result of the difference matrix).

When the difference matrix is compressed by the CSR method in the difference matrix compression unit 13, the difference matrix restoration unit 23 may restore the difference matrix by a method corresponding to the CSR method.

When the difference matrix is compressed by the COO method in the difference matrix compression unit 13, the difference matrix restoration unit 23 may restore the difference matrix by a method corresponding to the COO method.

When the difference matrix is compressed in the difference matrix compression unit 13 using the third compression method, the difference matrix restoration unit 23 receives elements of one row and the index of the row, or elements of one column and the index of the column. Here, the case in which the difference matrix restoration unit 23 receives elements of one row and the index of the row is used. In this case, the difference matrix restoration unit 23 restores the difference matrix by generating a symmetric matrix in which the row indicated by the index and the column corresponding to the row contain the elements of the one row, and the remaining elements are set to 0. For example, it is assumed that the difference matrix restoration unit 23 receives each element of the second row shown in FIG. 2 and the index “2” of the row. In this case, the difference matrix restoration unit 23 restores the difference matrix shown in FIG. 2 by generating a symmetric matrix in which the second row and second column contain the elements of the one row and the remaining elements are set to 0.

The difference matrix restoration unit 23 inputs the restored difference matrix to the latest matrix derivation unit 24.

The latest matrix derivation unit 24 derives the latest matrix based on the restored difference matrix and the previous matrix stored in the previous matrix storage unit 21. Specifically, the latest matrix derivation unit 24 derives the latest matrix by adding the restored difference matrix and the previous matrix. The derived latest matrix is the same as the latest matrix input to the terminal 1. The latest matrix derivation unit 24 inputs the derived latest matrix to the solution unit 25.

The latest matrix derivation unit 24 derives the latest matrix, inputs the latest matrix to the solution unit 25, and then updates the previous matrix stored in the previous matrix storage unit 21 with the latest matrix. The latest matrix stored in the previous matrix storage unit 21 is treated as the previous matrix the next time the problem receiving unit 22 receives the difference matrix after compression and the latest vector.

The solution unit 25 uses the latest matrix input from the latest matrix derivation unit 24 and the latest vector input from the problem receiving unit 22 to find a solution to the combinatorial optimization problem (in other words, the optimal states of individual spins). The solution unit 25 may, for example, use simulated annealing to find a solution to the combinatorial optimization problem.

When the latest matrix and the latest vector are input from the problem receiving unit 22, the solution unit 25 uses the latest matrix and the latest vector to find a solution to the combinatorial optimization problem.

The solution unit 25 inputs the obtained solution (the solution to the combinatorial optimization problem) to the solution transmission unit 26.

The solution transmission unit 26 transmits the solution to the combinatorial optimization problem input from the solution unit 25 to the terminal 1. The solution is received by the solution receiving unit 15 of the terminal 1.

The problem receiving unit 22 and the solution transmission unit 26 are realized, for example, by a CPU of a computer that operates according to a combinatorial optimization problem solution program, and by a communication interface of the computer. In this case, the CPU may read the combinatorial optimization problem solution program from a program recording medium such as a program storage device of the computer, and operates as the problem receiving unit 22 and the solution transmission unit 26 according to the program and using the communication interface.

The difference matrix restoration unit 23, the latest matrix derivation unit 24, and the solution unit 25 are realized, for example, by the CPU of the computer that operates according to the combinatorial optimization problem solution program. In this case, the CPU may read the combinatorial optimization problem solution program from the program recording medium such as the program storage device of the computer, as described above, and operate as the difference matrix restoration unit 23, the latest matrix derivation unit 24, and the solution unit 25.

The previous matrix storage unit 21 is realized by a storage device provided by the computer.

Next, the processing flow is described. In the present example embodiment, the solution system solves the combinatorial optimization problem repeatedly. For each combinatorial optimization problem, the latest matrix and the latest vector representing the combinatorial optimization problem are input to the terminal 1. In the following explanations, the explanation is divided into the case where the latest matrix and the latest vector are input to the terminal 1 for the first time (i.e., the combinatorial optimization problem is solved for the first time) and the case where the latest matrix and the latest vector are input to the terminal 1 for the second and subsequent times (i.e., the combinatorial optimization problem is solved for the second and subsequent times). In the following, the matters that have already been explained are omitted as appropriate.

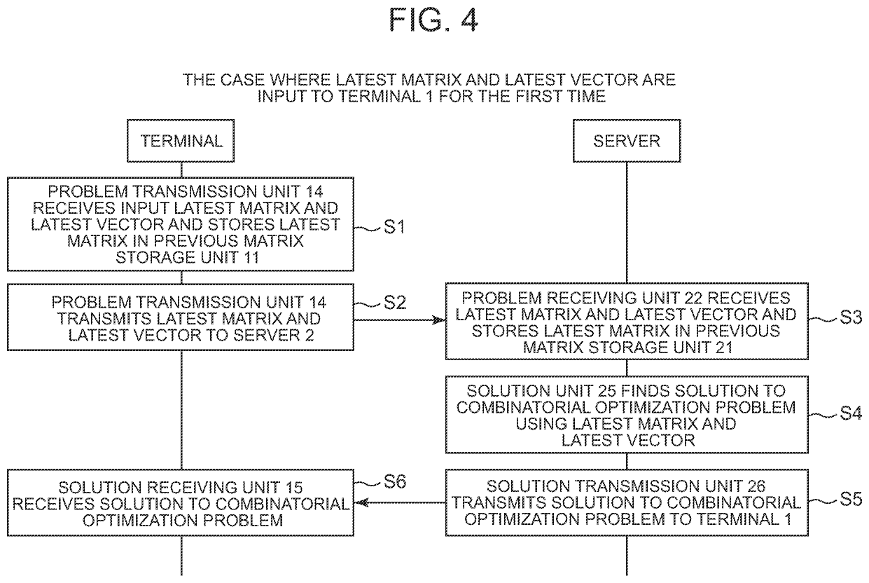

FIG. 4 shows a sequence diagram showing an example of the processing flow in the case where the latest matrix and the latest vector are input to the terminal for the first time. At the time when the latest matrix and the latest vector are input to the terminal 1 for the first time, a matrix representing the combinatorial optimization problem is not stored in the previous matrix storage unit 11 of the terminal 1 and the previous matrix storage unit 21 of the server 2

When the latest matrix and the latest vector are input to the terminal 1 for the first time, the problem transmission unit 14 of the terminal 1 receives the input latest matrix and the input latest vector and stores the latest matrix in the previous matrix storage unit 11 (step S1). The latest matrix stored in the previous matrix storage unit 11 in step S1 is treated as the previous matrix the next time the latest matrix and the latest vector are input to the terminal 1.

After step S1, the problem transmission unit 14 transmits the latest matrix and the latest vector to the server 2 (step S2).

The problem receiving unit 22 of the server 2 receives the latest matrix and the latest vector and stores the latest matrix in the previous matrix storage unit 21 (Step S3). At this time, the problem receiving unit 22 inputs the latest matrix and the latest vector to the solution unit 25. The latest matrix stored in the previous matrix storage unit 21 in step S3 is treated as the previous matrix the next time the problem receiving unit 22 receives the compressed difference matrix and the latest vector.

The solution unit 25 finds a solution to the combinatorial optimization problem using the latest matrix and the latest vector (step S4).

Next, the solution transmission unit 26 transmits the solution to the combinatorial optimization problem obtained in step S4 to the terminal 1 (step S5).

The solution receiving unit 15 of the terminal 1 receives the solution to the combinatorial optimization problem (step S6).

Next, the case where the latest matrix and the latest vector are input to the terminal 1 for the second and subsequent times is described. In this case, the previous matrix is stored in the previous matrix storage unit 11 of the terminal 1 and the previous matrix storage unit 21 of the server 2.

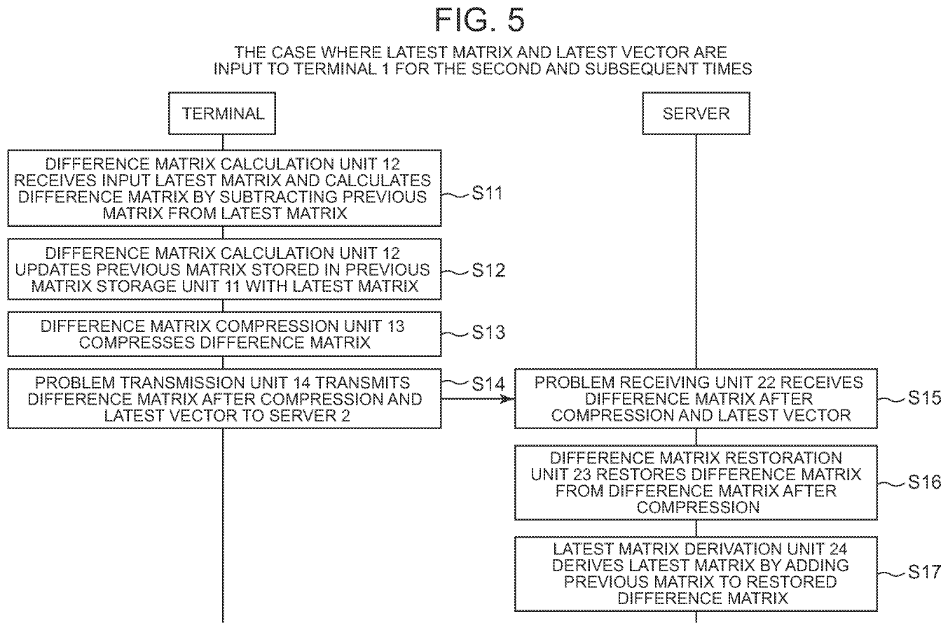

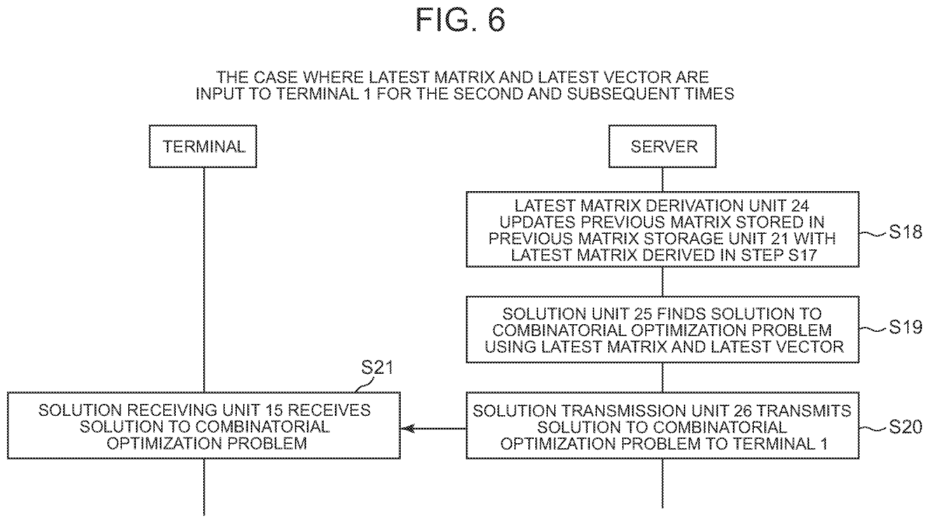

FIG. 5 and FIG. 6 are sequence diagrams showing an example of the processing flow in the case where the latest matrix and the latest vector are input to the terminal 1 for the second and subsequent times.

When the latest matrix and the latest vector are input to the terminal 1, the difference matrix calculation unit 12 of the terminal 1 receives the latest matrix and calculates the difference matrix by subtracting the previous matrix stored in the previous matrix storage unit 11 from the latest matrix (step S11). The problem transmission unit 14 receives the input latest vector.

After step S11, the difference matrix calculation unit 12 updates the previous matrix stored in the previous matrix storage unit 11 with the latest matrix (step S12). The latest matrix stored in the previous matrix storage unit 11 in step S12 is treated as the previous matrix in the next step S11.

Next, the difference matrix compression unit 13 compresses the difference matrix calculated in step S11 (step S13).

Next, the problem transmission unit 14 transmits the difference matrix after compression (the result of the compression of the difference matrix) and the latest vector to the server 2 (step S14).

The problem receiving unit 22 of the server 2 receives the difference matrix after compression and the latest vector (step S15). Here, the problem receiving unit 22 inputs the difference matrix after compression (the result of the compression of the difference matrix) to the difference matrix restoration unit 23 and inputs the latest vector to the solution unit 25.

The difference matrix restoration unit 23 restores the difference matrix from the difference matrix after compression (step S16).

Next, the latest matrix derivation unit 24 derives the latest matrix by adding the previous matrix stored in the previous matrix storage unit 21 to the restored difference matrix (step S17). The latest matrix derived in step S17 is the same matrix as the latest matrix input to the terminal 1. The latest matrix derivation unit 24 inputs the derived latest matrix to the solution unit 25.

The latest matrix derivation unit 24 updates the previous matrix stored in the previous matrix storage unit 21 with the latest matrix derived in step S17 (step S18, see FIG. 6). The latest matrix stored in the previous matrix storage unit 21 in step S18 is treated as the previous matrix in the next step S17.

The solution unit 25 finds the solution to the combinatorial optimization problem using the latest matrix and the latest vector (step S19).

Next, the solution transmission unit 26 transmits the solution to the combinatorial optimization problem obtained in step S19 to the terminal 1 (step S20).

The Solution receiving unit 15 of the terminal 1 receives the solution to the combinatorial optimization problem (step S21).

In the present example embodiment, in the terminal 1, the difference matrix calculation unit 12 calculates the difference matrix, which is the difference between the latest matrix and the previous matrix. Here, when the previous matrix and the latest matrix are compared, many elements are common and only some elements are different. Therefore, the difference matrix is a sparse matrix. The difference matrix compression unit 13 compresses the difference matrix, and the problem transmission unit 14 transmits the difference matrix after compression and the latest vector to the server 2. In this way, the difference matrix after compression and the latest vector are transmitted from the terminal 1 to the server 2, except in the case of solving the combinatorial optimization problem for the first time. Even if the data volume of the matrix α representing the combinatorial optimization problem is large, the difference matrix after compression and the latest vector are transmitted and received, except in the case of solving the combinatorial optimization problem for the first time. Therefore, when information on the combinatorial optimization problem is transmitted from the terminal 1 to the server 2, and server 2 receives the information and finds the solution to the combinatorial optimization problem, the communication volume of information transmitted from the terminal 1 to the server 2 can be reduced.

The latest vector is not compressed, and the latest vector input to the terminal 1 is transmitted as it is from the terminal 1 to the server 2. Since the data volume of vector is small, even if the latest vector is transmitted as it is from the terminal 1 to the server 2, it does not affect the communication cost very much and is not a problem.

In the server 2, the difference matrix restoration unit 23 restores the difference matrix from the difference matrix after compression, and the latest matrix derivation unit 24 derives the latest matrix based on the difference matrix and the previous matrix. Then, the solution unit 25 finds a solution to the combinatorial optimization problem using the latest matrix and the latest vector, and the solution transmission unit 26 transmits the solution to the terminal 1. Thus, server 2 can find a solution to the combinatorial optimization problem and return the solution to the terminal 1.

Next, a variation of the example embodiment of the present invention will be described.

The above example embodiment describes a case in which the latest vector is transmitted from the terminal 1 to the server 2 as it is. Even for vector, the terminal 1 may calculate and compress a difference vector, which is the difference between the vector representing the previous combinatorial optimization problem and the latest vector. The problem transmission unit 14 of the terminal 1 may then transmit the difference matrix after compression and the difference vector after compression to the server 2. The server 2 may then restore the difference vector from the difference vector after compression and derive the latest vector based on the restored difference vector and the vector representing the previous combinatorial optimization problem. As mentioned above, the data volume of vector is small. Therefore, even if terminal 1 transmits the latest vector to the server 2 as it is, as in the aforementioned example embodiment, if terminal 1 transmits the difference matrix after compression to the server 2, the effect of reducing the communication volume can be achieved.

In the above example embodiment, the CSR method, the COO method, and the third compression method were described as difference matrix compression method. The solution system may automatically select a compression method from among several types of compression methods. In this variation, the matrix α and the vector β representing the combinatorial optimization problem are repeatedly input to the terminal 1. The difference matrix compression unit 13 compresses the difference matrix, in the first predetermined times of inputs (e.g., five times), using the CSR method, the COO method, and the third compression method respectively, and adopts the compression result with the highest compression efficiency. The problem transmission unit 14 then transmits the difference matrix after compression, the latest vector, and information indicating the compression method corresponding to the adopted compression result to the server 2. The difference matrix restoration unit 23 of the server 2 may restore the difference matrix using the restoration method corresponding to the compression method. For inputs after the first predetermined times of inputs (e.g., five times), the difference matrix is compressed using the compression method that was most frequently adopted in the first predetermined times.

In the above example embodiment, the case where given the energy function of the Ising model, the matrix α and the vector β representing a combinatorial optimization problem are given is explained. The energy function of QUBO (Quadratic Unconstrained Binary Optimization) may be used as an energy function that can represent the combinatorial optimization problem.

QUBO is a model in which the states of individual spins are represented by “1” or “0”. “1” in QUBO can be referred to as the first value, similar to “1” in the Ising model. Also, “0” in QUBO can be referred to as the second value, similar to “−1” in the Ising model.

The expression representing the energy in a combinatorial optimization problem can also be converted to the energy function of QUBO. This conversion method is known. The energy function of the Ising model and the energy function of QUBO can be converted to each other.

The energy function of QUBO is expressed as in Expression (3) below.

[Math. 3]

H_{QUBO}=ΣᵢⱼQᵢⱼxᵢxⱼ (3)

Both i and j in Expression (3) are variables representing a spin. In addition, xᵢ in Expression (3) is a variable representing the state of spin i, and xⱼ is a variable representing the state of spin j. Qᵢⱼ in Expression (3) is a constant corresponding to a combination of spin i and spin j. For each combination of possible value of i and possible value of j, Qᵢⱼ is determined as a constant.

There are K² constants Qᵢⱼ in Expression (3) when the number of spins is K. A set of constants Qᵢⱼ is represented by a matrix with K rows and K columns. That is, the constant Qᵢⱼ corresponding to a combination of two spins is an element of the matrix with K rows and K columns. This matrix is a symmetric matrix.

This matrix, like the matrix α described above, can also be said to be a matrix representing a combinatorial optimization problem. Given the energy function of Expression (3), the above matrix is also given. Note that in QUBO, a vector such as vector β is not given.

In the aforementioned example embodiment, a matrix with K² constants Qᵢⱼ as elements may be applied. In this case, since no vector is given in QUBO, the processing related to vector described in the aforementioned example embodiment need not be performed. Other respects are the same as in the aforementioned example embodiment.

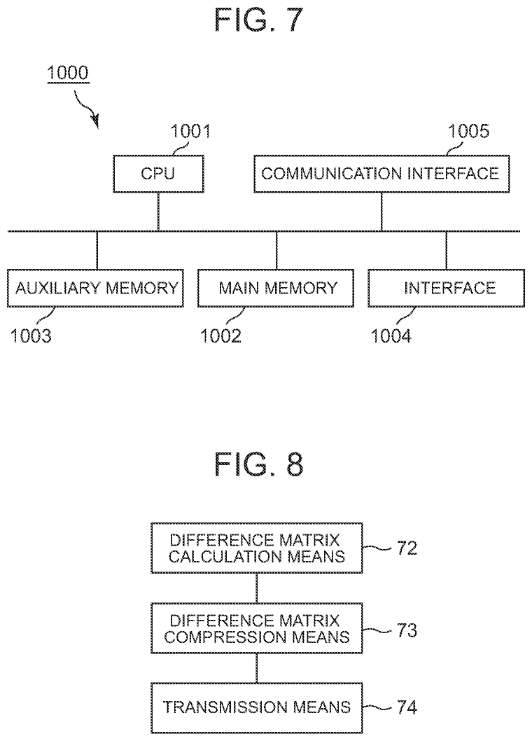

Next, an example of computer configuration that realizes the combinatorial optimization problem information transmission device 1 and the combinatorial optimization problem solution device 2 are described. The combinatorial optimization problem information transmission device 1 and the combinatorial optimization problem solution device 2 are realized by separate computers. However, both computer configurations for realizing these two devices can be represented as illustrated in FIG. 7. The computer 1000 illustrated in FIG. 7 includes a CPU 1001, a main memory 1002, an auxiliary memory 1003, an interface 1004, and a communication interface 1005.

In the computer 1000 operating as the combinatorial optimization problem information transmission device 1, a combinatorial optimization problem information transmission program is stored in the auxiliary memory 1003. The CPU 1001 reads the program from the auxiliary memory 1003, expands the program to the main memory 1002 and executes the process of the combinatorial optimization problem information transmission device 1 of the above example embodiment according to the program.

In the computer 1000 operating as the combinatorial optimization problem solution device 2, a combinatorial optimization problem solution program is stored in the auxiliary memory 1003. The CPU 1001 reads the program from the auxiliary memory 1003, expands the program to the main memory 1002 and executes the process of the combinatorial optimization problem solution device 2 of the above example embodiment according to the program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc.

Next, an overview of the present invention is described. FIG. 8 is a block diagram showing an overview of the combinatorial optimization problem information transmission device of the present invention. The combinatorial optimization problem information transmission device includes difference matrix calculation means 72, difference matrix compression means 73, and transmission means 74.

The difference matrix calculation means 72 (e.g., the difference matrix calculation unit 12) calculates a difference matrix which is a difference between a first matrix (e.g., the previous matrix) representing a combinatorial optimization problem for which a solution was found last time and a second matrix (e.g., the latest matrix) representing the latest combinatorial optimization problem.

The difference matrix compression means 73 (e.g., the difference matrix compression unit 13) compresses the difference matrix.

The transmission means 74 (e.g., the problem transmission unit 14) transmits the difference matrix after compression to a combinatorial optimization problem solution device (e.g., the server 2) that finds a solution to the combinatorial optimization problem.

According to such a configuration, it is able to reduce the communication volume of information transmitted from the combinatorial optimization problem information transmission device to the combinatorial optimization problem solution device can be reduced.

The difference matrix compression means 73 may compress the difference matrix by CSR method.

The difference matrix compression means 73 may compress the difference matrix by COO method.

The combinatorial optimization problem may be a combinatorial optimization problem having a property in which, when comparing the first matrix and the second matrix, elements of a row and a column corresponding to the row differ and the other elements are common, and the difference matrix compression means 73 may define a row of the difference matrix and an index of the row, wherein the row corresponds to a row whose elements are different between the first matrix and the second matrix, or a column of the difference matrix and an index of the column, wherein the column corresponds to a column whose elements are different between the first matrix and the second matrix, as a result of compression of the difference matrix.

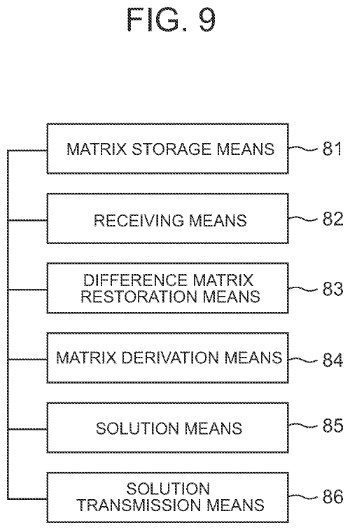

FIG. 9 is a block diagram showing an overview of the combinatorial optimization problem solution device of the present invention. The combinatorial optimization problem solution device includes matrix storage means 81, receiving means 82, difference matrix restoration means 83, matrix derivation means 84, solution means 85, and solution transmission means 86.

The matrix storage means 81 (e.g., the previous matrix storage unit 21) stores a first matrix (e.g., the previous matrix) representing a combinatorial optimization problem for which a solution was found last time.

The receiving means 82 (e.g., the problem receiving unit 22) receives a result of compression of a difference matrix which is a difference between the first matrix and a second matrix (e.g., the latest matrix) representing the latest combinatorial optimization problem, from a combinatorial optimization problem information transmission device (e.g., the terminal 1) that transmits information on the combinatorial optimization problem.

The difference matrix restoration means 83 (e.g., the difference matrix restoration unit 23) restores the difference matrix from the result of compression.

The matrix derivation means 84 (e.g., the latest matrix derivation unit 24) derives a the second matrix based on the restored difference matrix and the first matrix.

The solution means 85 (e.g., the solution unit 25) finds a solution to the combinatorial optimization problem using the derived second matrix.

The solution transmission means 86 (e.g., the solution transmission unit 26) transmits the solution to the combinatorial optimization problem information transmission device.

Although the present invention has been described above with reference to the example embodiment, the present invention is not limited to the above example embodiment. Various changes may be made to the structure and details of the present invention, that may be understood by those skilled in the art within the scope of the present invention.

### INDUSTRIAL APPLICABILITY

The present invention is suitably applied to a solution system in which a combinatorial optimization problem information transmission device transmits information on a combinatorial optimization problem to a combinatorial optimization problem solution device, and the combinatorial optimization problem solution device finds a solution to the combinatorial optimization problem.

### REFERENCE SIGNS LIST

1 Terminal (Combinatorial optimization problem information transmission device)
2 Server (Combinatorial optimization problem solution device)
11 Previous matrix storage unit
12 Difference matrix calculation unit
13 Difference matrix compression unit
14 Problem transmission unit
15 Solution Receiving unit
21 Previous matrix storage unit
22 Problem receiving unit
23 Difference matrix restoration unit
24 Latest matrix derivation unit
25 Solution unit
26 Solution transmission unit

What is claimed is:

1. A combinatorial optimization problem information transmission device comprising:
a memory configured to store instructions; and
a processor configured to execute the instructions to:
calculate a difference matrix which is a difference between a first matrix representing a combinatorial optimization problem for which a solution was found last time and a second matrix representing the latest combinatorial optimization problem;
compress the difference matrix; and
transmit the difference matrix after compression to a combinatorial optimization problem solution device that finds a solution to the combinatorial optimization problem.

2. The combinatorial optimization problem information transmission device according to claim 1,
wherein the processor compresses the difference matrix by CSR (Compressed Sparse Row) method.

3. The combinatorial optimization problem information transmission device according to claim 1,
wherein the processor compresses the difference matrix by COO (COOdinate) method.

4. The combinatorial optimization problem information transmission device according to claim 1,
wherein the combinatorial optimization problem is a combinatorial optimization problem having a property in which, when comparing the first matrix and the second matrix, elements of a row and a column corresponding to the row differ and the other elements are common, and
the processor
defines a row of the difference matrix and an index of the row, wherein the row corresponds to a row whose elements are different between the first matrix and the second matrix, or a column of the difference matrix and an index of the column, wherein the column corresponds to a column whose elements are different between the first matrix and the second matrix, as a result of compression of the difference matrix.

5. A combinatorial optimization problem solution device comprising:
a memory configured to store instructions; and
a processor configured to execute the instructions to:
store a first matrix representing a combinatorial optimization problem for which a solution was found last time;
receive a result of compression of a difference matrix which is a difference between the first matrix and a second matrix representing the latest combinatorial optimization problem, from a combinatorial optimization problem information transmission device that transmits information on the combinatorial optimization problem;
restore the difference matrix from the result of compression;
derive the second matrix based on the restored difference matrix and the first matrix;
find a solution to the combinatorial optimization problem using the derived second matrix; and
transmit the solution to the combinatorial optimization problem information transmission device.

6. A solution system comprising:
a combinatorial optimization problem information transmission device that transmits information on a combinatorial optimization problem; and
a combinatorial optimization problem solution device that finds a solution to the combinatorial optimization problem,
wherein the combinatorial optimization problem information transmission device comprises:
a first memory configured to store instructions; and
a first processor configured to execute the instructions to:
calculate a difference matrix which is a difference between a first matrix representing the combinatorial optimization problem for which the solution was found last time and a second matrix representing the latest combinatorial optimization problem;
compress the difference matrix; and
transmit the difference matrix after compression to the combinatorial optimization problem solution device, and
wherein the combinatorial optimization problem solution device comprises:
a second memory configured to store instructions; and
a second processor configured to execute the instructions to:
store the first matrix;
receive the difference matrix after compression from the first processor of the combinatorial optimization problem information transmission device;
restore the difference matrix from the difference matrix after compression;
derive the second matrix based on the restored difference matrix and the first matrix;
find the solution to the combinatorial optimization problem using the derived second matrix; and
transmit the solution to the combinatorial optimization problem information transmission device.

7-10. (canceled)
